(19) United States
(12) Patent Application Publication
(10) Pub. No.: US 2024/0109752 A1
(43) Pub. Date: Apr. 4, 2024

(54) ELEVATOR SAFETY SYSTEM

(71) Applicant: Otis Elevator Company, Farmington, CT (US)

(72) Inventors: Stephane Gourjeande, Gien (FR); Marcos Leon Atienza, Leganés (ES); Javier Munoz Sotoca, Rivas-Vaciamadrid (ES); Luis Mena, Getafe (ES)

(21) Appl. No.: 17/985,667

(22) Filed: Nov. 11, 2022

(30) Foreign Application Priority Data
Sep. 30, 2022 (EP) 22382908.6

(51) Int. Cl. B66B 5/00

(52) U.S. Cl. CPC B66B 5/0031; B66B 5/0043

(57) ABSTRACT

An elevator system (1) including at least one refuge space (7, 8) and at least one sensor (9). The at least one sensor (9) is configured to detect weight in the at least one refuge space (7, 8) and produce at least one safety signal (21) indicating the presence of weight in the at least one refuge space (7, 8). The system can be used to improve the safety in the at least one refuge space (7, 8) in the event that the usual safety procedures have either failed or not been followed. For example, if for some reason the elevator system (1) has not been placed into a safe state before a maintenance worker (10) accesses the at least one refuge space (7, 8), the system will detect them and can produce at least one safety signal immediately indicating their presence in the at least one refuge space.

### FOREIGN PRIORITY

This application claims priority to European Patent Application No. 22382908.6, filed Sep. 30, 2022, and all the benefits accruing therefrom under 35 U.S.C. § 119, the contents of which in its entirety are herein incorporated by reference.

### TECHNICAL FIELD

This disclosure relates to a safety system for an elevator system. In particular, the disclosure relates to elevator systems with refuge spaces that can be accessed by people, for example maintenance workers.

### BACKGROUND

Elevator systems have areas that pose an increased level of risk and danger to people who occupy the space, but which must be accessed in order to perform maintenance work on the elevator system. Examples of such spaces include the top of the elevator car and the pit at the bottom of the elevator shaft.

These higher-risk areas can each have a corresponding refuge space, which is a space which can accommodate a person safely during an emergency. For example, when the elevator car is at its highest position in the elevator shaft, a refuge space may provide a sufficient gap between the roof of the elevator car and the top of the elevator shaft. This gap may be large enough for a person to stand, crouch, or lie in, and prevents them from being injured even when the elevator car is at its highest point in the elevator shaft. A similar refuge space can be provided between the bottom of the elevator car and the bottom of the elevator shaft when the elevator car is in its lowest position in the elevator shaft.

There are existing measures which are implemented in order to make these spaces safer for people who need to access them. For example, if a maintenance worker needs to access the top of the elevator car, there is a safety protocol to follow that should ensure that the elevator system is safe before they proceed to the top of the elevator car. Once on top of the elevator car, they will typically then activate an inspection switch. This places the elevator car into an “inspection mode” in which the elevator car can only be moved by the maintenance worker. Controls for moving the elevator car in the inspection mode are typically also on the roof of the elevator car.

However, there are problems with this system. In particular, it is possible for the other safety systems to fail. Alternatively, a maintenance worker who is busy or lazy may not fully or correctly follow the other safety procedures. If the other safety systems are not active for some reason, then the elevator car is placed in inspection mode, the elevator system may still be operational and thus it could be controlled (e.g. due to a new call) to move at full speed. There is then a risk of the person in the refuge space becoming trapped or injured.

### SUMMARY

According to a first aspect of the present disclosure, there is provided an elevator system, comprising: at least one refuge space; and at least one sensor; wherein the at least one sensor is configured to: detect weight in the at least one refuge space; and produce at least one safety signal indicating the presence of weight in the at least one refuge space.

This system enables detection of objects in the refuge space of an elevator system without any action required by the object in the refuge space. This presents advantages over the safety systems currently known in the art.

For example, the system can be used to improve the safety in the refuge space in the event that the usual safety procedures have either failed or not been followed. For example, if for some reason the elevator system has not been placed into a safe state before a maintenance worker accesses the refuge space, the system will detect them and can produce a safety signal immediately indicating their presence in the refuge space.

By detecting weight in the refuge space, the system can be confident that a significant object (which may be a person) is present in the refuge space. By contrast, other sensors such as light sensors can be triggered by stray reflections or blocked by dust or minor debris. As the safety response of the system may be to stop the elevator car from normal operation, false positives should ideally be avoided or kept to a very low level.

The elevator system can be any elevator system known in the art. The elevator system can be a roped system in which the elevator car is hoisted using e.g. ropes, chains or belts, or the elevator system may be lifted by hydraulics. The elevator car may also be ropeless, e.g. a beam climber system or a linear motor driven system. The elevator system can include any number of elevator cars and any number of elevator shafts. The elevator system can be configured to carry goods of any weight and/or size, and may comprise for example a passenger, service or freight elevator system or combinations thereof.

The refuge space is generally a small area of safety for a person to use during an emergency. In general, it is large enough for a single person either to stand, crouch, or lay down. Its dimensions can be dependent on local building codes and the size and age of the elevator system.

The sensor can be any sensor that can detect weight. For example, pressure sensors, stress sensors, or strain sensors can all be suitably arranged to detect weight. The response of the sensor to an object in the refuge space can be binary or two-state, meaning that the output is either OFF or low, indicating no weight is present, or the output is ON or high indicating the presence of an object in the refuge space. Alternatively, the response of the sensor to an object in the refuge space can be linear, meaning that the output is proportional to the weight of the object in the refuge space. The output may be of any suitable form, e.g. a voltage output or a current output, etc.

The safety signal can be any signal that is suitable for communicating information. For example, the safety signal could simply indicate the presence or absence of an object in the refuge space. In some examples, the safety signal can include more information, for example the location of the elevator system and/or the location of the sensor. The safety signal can be sent in any conventional manner, for example over a wired connection or a wireless connection. The safety signal may be analogue or it may be a digital signal which may be encoded in a packet. For example, the safety signal may be sent over a wireless internet connection, short range wireless protocols such as Bluetooth, or as an analogue electrical signal.

It will be appreciated that the system can detect any object with weight. In many examples, the object will be a person or people, e.g. maintenance workers accessing the hoistway for inspection and/or repair. In some potentially overlapping examples, the object is inanimate, for example a toolbox or debris.

In some examples, the at least one refuge space comprises a refuge space on the top of the elevator car. The refuge space on top of the elevator car is generally a small area between the roof on the top of the elevator car and the top (ceiling) of the elevator shaft. The refuge space keeps a maintenance worker safe if the elevator car travels to the highest floor of a building.

In some examples, the at least one sensor comprises at least one of a load sensor, a strain sensor, a stress sensor, and/or a pressure sensor. In some examples, the at least one sensor is installed in the floor of the refuge space. The number of sensors used can depend on a number of factors, including for example one or more of: the area of the floor (i.e. the size of the elevator car/elevator shaft); the maximum expected load and sensitivity of each sensor; or the level of redundancy required. If there is a plurality of sensors, they can work individually e.g. to detect load in different positions in the refuge space (e.g. to detect one person in different places or to detect multiple people), or they can work together to provide a level of redundancy to the system e.g. to check that the amount of weight detected is the same, or to continue to provide a reading even if one sensor fails.

In some examples, the at least one refuge space comprises a refuge space in the elevator pit. In such examples, the refuge space is generally a small area between the bottom of the elevator shaft and the bottom of the elevator car when it is at its lowest point in the hoistway. The refuge space keeps a maintenance worker safe when working in the elevator pit and when an elevator car travels to the lowest floor of the building.

In some examples, the at least one sensor comprises sensitive flooring. The sensitive flooring can be any type of flooring, for example a mat, carpet, or tiles that can sense weight applied to them. The flooring can generally be placed on the floor of the refuge space or can be secured to the floor of the refuge space using an adhesive or other fixing members (such as nails or screws). In some examples, the at least one sensor comprises a sensitive carpet.

In some examples, the sensor comprises a piezoelectric material. A piezoelectric material produces an electric charge in response to mechanical stress. In such examples, the weight of an object on the piezoelectric material produces an electric charge which can be used to initiate the safety signal. In some examples, the piezoelectric material is embedded into or placed under another material such as a carpet, tiles or other floor covering. In some examples, the piezoelectric material may be provided in the form of a plurality of pads. Each pad may be a separate sensor providing its own output, or all pads may be connected together to form one sensor. The pads may be arranged in a regular pattern, e.g. a grid, tiles or other repeating pattern. In some examples, the pads may be irregularly distributed across the refuge space. In some examples, the surface area of each pad, e.g. of each piezoelectric element may be up to 100 cm², optionally up to 50 cm², optionally up to 10 cm², optionally up to 5 cm², optionally up to 1 cm². The choice of size may be made depending on various factors such as cost, availability and desired sensor resolution. For example, smaller sensors can be used to create a high resolution grid for a high degree of localisation of the applied weight.

In some examples, the refuge space comprises one or more flat regions, and wherein at least one sensor is positioned in at least one of the flat regions. If a maintenance worker is working in the refuge space, they may be more likely to stand on at least one of the flat regions as this is more stable than a sloping or stepped section. Therefore, the sensors may be more effective at detecting when a person is in the refuge space if they occupy at least one of the flat regions in the refuge space due to increased footfall in this area. In some examples, the flat regions may comprise an area at the entrance to the refuge space and/or a region in front of the control panels as these are areas most likely to be used.

In some examples, the elevator system comprises an elevator car having a crosshead, and wherein the at least one sensor comprises a sensor positioned on the crosshead. The crosshead is part of the frame around the elevator car which thus forms a raised section above the roof of the elevator car. The crosshead may be used as a platform during maintenance work due to its increased height. Therefore, sensors on the crosshead may be particularly useful for detecting when a person is in the refuge space even though they are not standing on the roof of the elevator car itself.

In some examples, when the at least one refuge space comprises a refuge space on the top of the elevator car, the at least one sensor is embedded in or fixed to the underside of the roof of the elevator car. The sensor may be arranged to detect load by sensing flexing or stretching of the roof caused by weight applied on the top of the roof.

In some examples, the elevator system further comprises an elevator controller, configured to receive the safety signal from the sensor wherein, upon receiving the safety signal from the sensor, the elevator controller is configured to implement a safety response. In such examples, the elevator controller may comprise a processor and a memory. The elevator controller may be configured to operate one or more elevator cars.

In some examples, the safety response comprises an emergency stop. An emergency stop may include disconnecting the motor and brake from power, which results in the brake being applied. The elevator car is therefore stopped very rapidly, thereby reducing the risk to the person in the refuge space of the elevator system.

In some examples, the safety response comprises moving the elevator car at a reduced speed. Travelling at a lower speed ensures that the maintenance worker has more time to react if the elevator car starts moving, e.g. by putting the elevator system into inspection mode or pressing the emergency stop button. Additionally, it ensures a higher level of safety and comfort for any passengers currently inside the elevator car by reducing the magnitude of a sudden stop.

In some examples, the safety response comprises operating the elevator system in a pre-inspection operational mode. The pre-inspection operational mode can disable the elevator system so as to put it in a safe state. For example, it may prevent the elevator car from moving and/or may prevent it from servicing passenger calls. The inspection switch is operable by a maintenance worker, and is situated in the refuge space. After the inspection switch is activated, the elevator system can be operated in an inspection mode by controls in the refuge space, which will be discussed further below.

In some examples, the safety response comprises operating the elevator system in an inspection mode. When inspection mode is activated, only the maintenance worker can operate the elevator car. The controls to operate the elevator car during inspection mode are in the refuge space. During inspection mode, the elevator system cannot respond to hall calls or requests for service.

In some examples, the safety response comprises illuminating the at least one refuge space. In such examples, a light may be configured to increase visibility in order to aid maintenance work in the refuge space. In some potentially overlapping examples, a light is configured as a warning light used to alert the person in the refuge space that they are in an unsafe situation. In some examples, illuminating the refuge space may comprise illuminating the refuge space with a strong light sufficient for carrying out maintenance work. For example, the illumination may be at least 100 lux, at least 200 lux, or at least 500 lux. In some cases, low-level emergency or permanent lighting may already be present for safety reasons, but the safety response may comprise increasing the illumination level, e.g. to the levels mentioned above.

In some examples, the safety response comprises sending a signal to a communications centre or a building manager. In some examples, this signal comprises information about the event or emergency that triggered the signal. For example, the signal could include one or more of: the location of the elevator car (e.g. address or location inside the building, optionally including any of: a floor identifier, elevator car identifier, hoistway identifier, etc.); the weight detected (e.g. in Newtons or another equivalent measurement or unit), the number of weights detected, and/or the location of the weights in the refuge space; or the status of the elevator car (e.g. whether it is moving, the door open/closed status, the inspection mode status, etc.). In some examples, the safety response can include making contact with the person in the refuge space, for example through an intercom system. The appropriate person can then ensure that further action is taken when necessary, for example making sure that the elevator system is placed in a suitably safe state and, in case that an unauthorized or unexpected access to the elevator shaft is detected, that the person or other object is removed from the refuge space safely.

In some examples, the elevator system further comprises a safety chain, configured to receive a safety signal from the sensor. In some examples, upon receiving the safety signal from the sensor, the safety chain is broken. Breaking the safety chain means that the overall state of the safety chain changes to indicate that a significant fault or incident has occurred. A safety chain may comprise a series of switches which are normally closed (conducting) such that the opening of any switch changes the safety chain to a non-conducting state. It will be appreciated that other arrangements of safety chain are possible. For example, breaking the safety chain could result in the safety chain becoming conductive rather than non-conductive. In some examples, when the safety chain is broken an emergency stop is initiated; however, the response can be any of those previously discussed. In some examples, the voltage of the safety signal matches that of a safety chain system (e.g. 48 V or 110 V in some examples). This can be achieved by suitable adaptation and modification of the output of the sensors, e.g. the piezoelectric sensors discussed above. This may be achieved by modifying a purchased (e.g. off-the-shelf and thus readily available, inexpensive) sensor or designing a specific sensor to operate in this manner. In some examples, the safety chain comprises a PESSRAL system (Programmable Electronic Systems in Safety Related Application for Lifts).

In some examples, the at least one sensor is arranged not to send the safety signal if the weight is below a minimum threshold. In some examples, the minimum threshold is no more than 50 kg (or its equivalent in Newtons or the like), optionally no more than 30 kg, optionally no more than 20 kg, optionally no more than 10 kg, optionally no more than 5 kg. In some examples, it may be preferable to send a safety signal only when a person is in the refuge space. Very small objects such as dust and debris and some larger objects such as toolboxes may not create a hazard. In such circumstances, sending a safety signal and initiating a safety response is unnecessary. Therefore, in some examples a weight threshold is set below which the safety signal is not sent, thereby avoiding unnecessary elevator system down time. The particular threshold can be selected according to individual circumstances and safety considerations, or the size of the refuge space. For example, in smaller elevator systems, the refuge space may be smaller, and hence a medium sized object such as a toolbox may pose more of a hazard than in a larger elevator system. However, in general the threshold can be chosen to at least exclude safety signals initiated as a result of small debris. For example, a threshold of 5 kg will exclude most small debris, but will include most larger sized objects such as a toolbox. A threshold of 30 kg will mean that most toolboxes will not trigger a safety signal, but most adult humans would trigger a safety signal.

In some examples, the elevator controller is configured to operate an elevator system in a post-inspection mode when the safety signal is no longer received. This may be for example when the maintenance worker is leaving the refuge space or when another object is removed from the refuge space. In such examples, when the elevator system is in post-inspection mode it may be configured such that the elevator car cannot move or take any further passengers until the post-inspection mode is deactivated. In such examples, the post-inspection mode is similar to the pre-inspection mode discussed above and ensures safety (e.g. as a backup to other safety systems) after the inspection mode switch has been set to disable the inspection mode, until the refuge space is fully clear (e.g. until a maintenance worker has left the refuge space). Therefore, the process for a maintenance worker leaving the refuge space is the reverse of the process for entering the refuge space.

According to a second aspect of the present disclosure, there is provided a method of detecting objects in an elevator system comprising: detecting, by at least one sensor, weight in at least one refuge space of the elevator system; producing, from the at least one sensor, at least one safety signal indicating the presence of weight in the at least one refuge space.

It will be appreciated that all of the features and advantages set out above in relation to the first aspect of the disclosure can equally be applied to the second aspect of the disclosure, i.e. they apply equally to the method of detecting objects in an elevator system.

### BRIEF DESCRIPTION OF THE DRAWINGS

Certain examples of the present disclosure will now be described with reference to the accompanying drawings in which:

FIG. 1 is a schematic view of an elevator system in accordance with an example of the present disclosure;

FIG. 2 is a schematic view of an elevator car with tiled sensors in accordance with an example of the present disclosure;

FIG. 3 is a schematic view of an elevator car with load sensors in accordance with an example of the present disclosure;

FIG. 4 is a schematic view of an elevator car with a crosshead in accordance with an example of the present disclosure;

FIG. 5 is a schematic view of an elevator pit in accordance with an example of the present disclosure;

FIG. 6 is a block diagram of a sensor system in accordance with an example of the present disclosure; and

FIGS. 7, 8, and 9 are flow charts showing methods of detecting objects in an elevator system in accordance with examples of the present disclosure.

### DETAILED DESCRIPTION

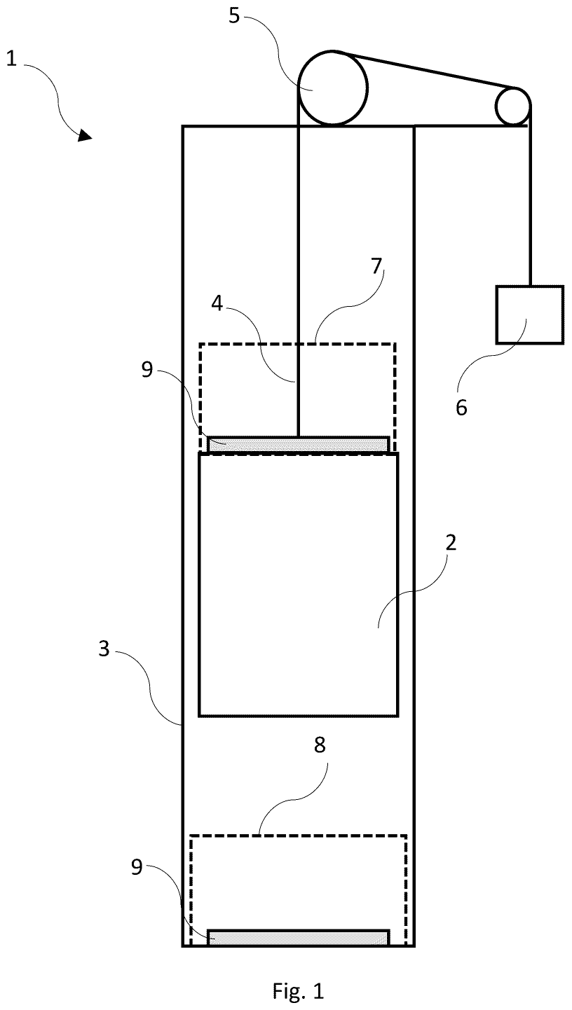

FIG. 1 shows a schematic view of an elevator system 1 according to an example of the present disclosure. The elevator system 1 includes an elevator car 2 arranged to move vertically in an elevator shaft 3. In this example, the elevator car 2 is connected by a rope 4 via a sheave 5 to a counterweight 6. The sheave 5 may be driven by a machine (not shown) so as to raise and lower the elevator car 2. It will be appreciated however, that the elevator system 1 can be operated by any suitable mechanism known in the art, including linear motors or beam climbers.

The elevator system 1 shown in FIG. 1 has two refuge spaces 7, 8. One refuge space 7 is on the roof of the elevator car 2. This refuge space 7 is used when the elevator car 2 is at its topmost position within the elevator shaft 3. When the elevator car 2 is in this position, the refuge space 7 must remain unobstructed so that a person can stand, crouch or lie (depending on the size of the refuge space 7) safely between the top of the elevator car 2 and the top of the elevator shaft 3.

The other refuge space 8 is at the bottom of the elevator shaft 3 (also called the elevator pit). This refuge space 8 is used when the elevator car 2 is at the bottom of the elevator shaft 3. When the elevator car 2 is at its lowermost position in the elevator shaft 3, it remains outside the refuge space 8 so that a person can stand, crouch or lie (depending on the size of the refuge space 8) safely between the bottom of the elevator shaft 3 and the bottom of the elevator car 2.

Where possible, it is advantageous to have both refuge spaces 7, 8 in the elevator system 1, as shown in the elevator system 1 of FIG. 1. In this example, each refuge space 7, 8 further includes a sensor 9. The sensor can be any type that is suitable for detecting weight in the refuge space 7, 8, for example a pressure sensor, stress sensor, or strain sensor. The sensor 9 can occupy the entire area of the refuge space 7, 8 or just a portion of it.

In some examples, the system 1 may have both refuge spaces 7, 8, but only one of the refuge spaces 7, 8 may have a sensor 9 in it. In some examples, the elevator system 1 may have a refuge space 7 on top of the elevator car 2, but no refuge space 8 in the elevator pit, while other examples may have a refuge space 8 in the elevator pit, but no refuge space 7 on top of the elevator car 2.

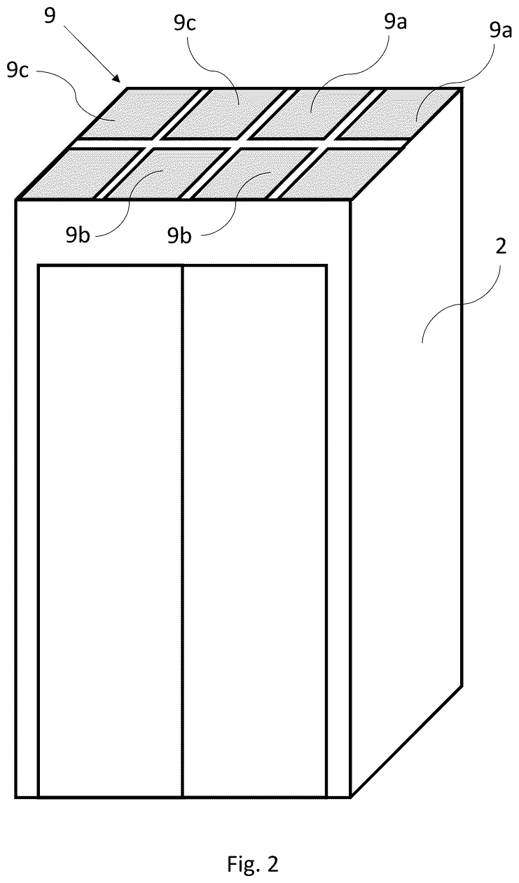

FIG. 2 shows a schematic view of an elevator car 2 with a sensor 9 that comprises a plurality of tiled sensors 9a according to an example of the present disclosure. In this example the individual tiled sensors 9a are shown in a rectangular grid pattern, but it will be appreciated that the number and configuration of the sensors 9a are not limited to this example. For example, the sensor 9a may be placed only in certain areas of importance or of high expected footfall. By way of illustration, one such example may include only sensors 9b above the elevator car doors (as entrance into the refuge space 7 through the hoistway doors would lead over these sensors 9b) and the sensors 9c adjacent to a control panel (e.g. with an inspection mode switch, emergency stop switch and up and down control buttons).

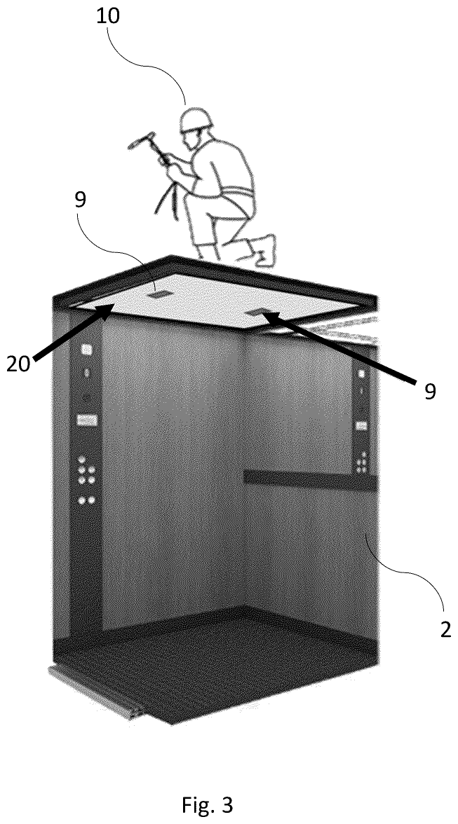

FIG. 3 shows a schematic view of an elevator car 2 with load sensors 9 according to an example of the present disclosure. Although two load sensors 9 are shown, it will be appreciated that in other examples only one load sensor 9 may be provided. The load sensors 9 are placed inside the elevator car 2 on the underside of the roof 20 so that they can detect weight on the roof (i.e. weight in the refuge space 7) by detecting flexing in the roof 20. A maintenance worker 10 can therefore be detected by the load sensor 9 if they step onto the refuge space 7 on top of the elevator car 2. The sensor 9 may alternatively comprise one or more strain sensors.

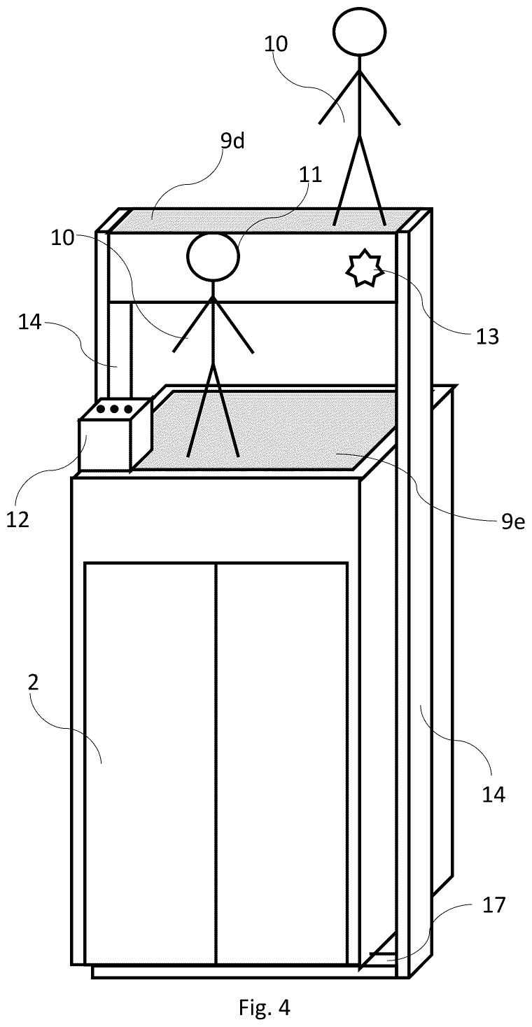

FIG. 4 shows a schematic view of an elevator car 2 with a crosshead 11, two sensors 9, a control panel 12, and a light 13 according to an example of the present disclosure. The crosshead 11 together with two uprights 14 and a structural plank 17 forms a support frame for the elevator car 2. The uprights 14 extend along the sides of the elevator car 2 and the structural plank 17 extends underneath the elevator car 2. The crosshead 11 may support various pieces of equipment or serve various functions (e.g. it may be the attachment point for a rope 4 or a sheave) but the crosshead 11 can also be used as a surface for standing on during maintenance work on the elevator system 1. Therefore, in this example a sensor 9d is placed on the crosshead 11 in order to detect a maintenance worker 10 standing on the crosshead 11 in addition to a sensor 9e on the roof of the elevator car 2. Two maintenance workers 10 are shown in FIG. 4 (which is not necessarily to scale) to illustrate detection by each of the two sensors 9d, 9e.

In this example, the second sensor 9e on the roof of the elevator car 2 extends over the flat surfaces of the roof of the elevator car 2. It does not extend over any portions that are not flat, for example the control panel 12, because a maintenance worker 10 is less likely to stand in these portions of the refuge space 7.

The control panel 12 can include buttons and/or switches for the maintenance worker 10 to control movement of the elevator car 2. For example, the control panel 12 may enable the maintenance worker 10 to move the elevator car 2 up and down the elevator shaft 3 and perform an emergency stop. The control panel 12 can further include an inspection switch to place the elevator car 2 in an inspection mode, whereby only the maintenance worker 10 is able to control movement of the elevator car 2.

In this example, there is a light 13 installed on the crosshead 11. The light 13 can be installed anywhere in the refuge space 7, for example on the control panel 12, in the elevator shaft 3, or around either of the sensors 9d, 9e. The light 13 can be used as part of the safety response to illuminate the refuge space 7, or as a warning light to let the maintenance worker 10 in the refuge space 7 know that they are in an unsafe situation or it may be used to provide (or to increase) illumination for working. In particular, the light 13 may provide an illumination in the refuge space 7 of at least 200 lux (preferably at least 300 lux or more). There may be a plurality of lights 13 (e.g. one on each side of the crosshead 11 or placed at different points on the roof of the elevator car 2), and they could perform either or both of the functions of illumination and warning. It will be appreciated that in some examples there may be one or more lights 13 for illumination and one or more lights 13 for warning.

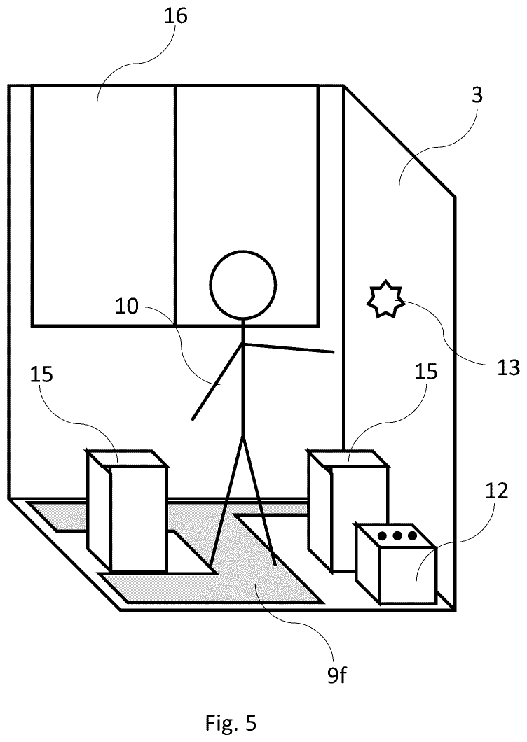

FIG. 5 shows a schematic view of the bottom of the elevator shaft 3 (also called the elevator pit) with a sensor 9, a control panel 12, and buffers 15 according to an example of the present disclosure. The refuge space 8 at the bottom of the elevator shaft 3 is accessed by the hoistway doors 16 from the lowermost landing. The elevator pit may include various pieces of equipment such as buffers 15 and control panel 12 and it may include other obstructions not illustrated with the refuge space 8 provided between them or adjacent to them.

The sensor 9f extends over certain parts of the floor of the elevator pit, including the refuge space 8. It does not extend over the portions that are not flat (e.g. the control panel 12 or the buffers 15), as a maintenance worker 10 is less likely to step on these areas. In FIG. 5, the sensor 9f is shown specifically shaped around these obstructions to cover a significant portion of the remaining flat area of the floor. It will be appreciated that the same principle may be applied on top of the elevator car 2 as shown in FIG. 4. As discussed above, the sensor 9f may be a single sensor or it may comprise an array of sensor elements. The sensor elements may each act as individual sensors with separate outputs, or they may all be connected together to act as a single sensor. The same principle also applies to the examples of FIG. 4.

The sensor 9f in this example may be a sensitive carpet that can be rolled out in the areas of interest and may be affixed to the floor of the elevator pit, e.g. with an adhesive, carpet grippers, nails or other fixings. The sensitive carpet may contain any types of sensors, but in particularly convenient examples includes a piezoelectric carpet with one or more piezoelectric sensors arranged to sense weight applied to the carpet (or to certain sensitive areas of the carpet). It will be appreciated that such sensitive carpet may also be used in the refuge space 7 on top of the elevator car 2 and it will equally be appreciated that the sensor(s) 9 in the refuge space 8 in the elevator pit may take different forms, e.g. load sensitive tiles (which again may be piezoelectric or may contain sensors with other sensing mechanisms such as load cells or strain sensors).

It will be appreciated that in the above examples, while the sensors 9 have been shown and described in relation to detection of a person such as a maintenance worker 10, the sensors 9 are equally capable of detecting an inanimate object such as a toolbox or large debris. The detection sensitivity of the sensors 9 can be adjusted so as to set the minimum threshold that triggers an alert so as to distinguish between items (weights) that are to be detected and/or alerted (e.g. persons) and items (weights) that do not require detection or alerting.

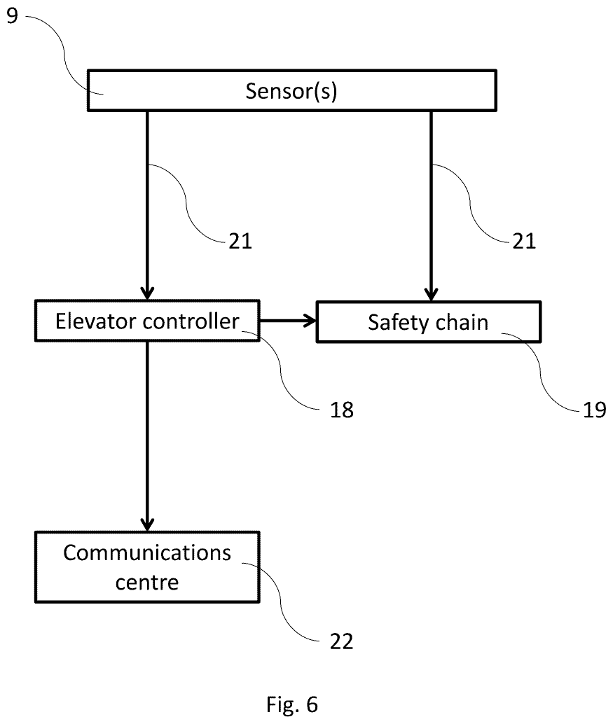

FIG. 6 schematically shows an elevator controller 18 and a safety chain 19 connected to the sensors 9 that can detect the presence of persons and/or other objects in the refuge spaces 7, 8. Upon detecting a weight in the refuge spaces 7, 8, the sensor(s) 9 produce and send a safety signal 21 to the elevator controller 18 and/or the safety chain 19 of the elevator system. The safety signal 21 initiates a suitable safety response, which can include one or more of the following actions: an emergency stop, moving the elevator car at a reduced speed; operating the elevator system in a pre-inspection mode; operating the elevator system in an inspection mode; illuminating the refuge space 7, 8 (e.g. via light 13); and/or sending a signal to a communications centre 22 or building manager A safety signal 21 from the sensor(s) 9 may directly break the safety chain 19, or in other examples a safety signal 21 from the sensor(s) 9 may cause the controller 18 to generate a signal that breaks the safety chain 19 (which may be dependent on some further analysis by the controller 18 of the safety signal 21).

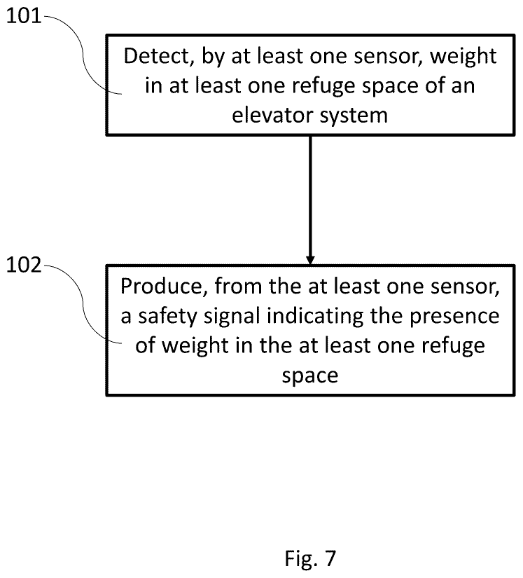

FIGS. 7, 8, and 9 are flow charts showing methods of detecting objects in an elevator system 1 according to various examples of the present disclosure.

In FIG. 7 at step 101 the weight is detected by the sensor 9 in the refuge space 7, 8. The sensor 9 then produces a safety signal at step 102, which indicates the presence of weight in the refuge space 7, 8. The safety signal may include any amount of information about the weight in the refuge space 7, 8. For example, it could be a simple on/off signal simply indicating that weight is present, or absent or it could be a continuous value indicating a level (i.e. amount) of weight detected. It may also include further information such as the location and status of the elevator car 2.

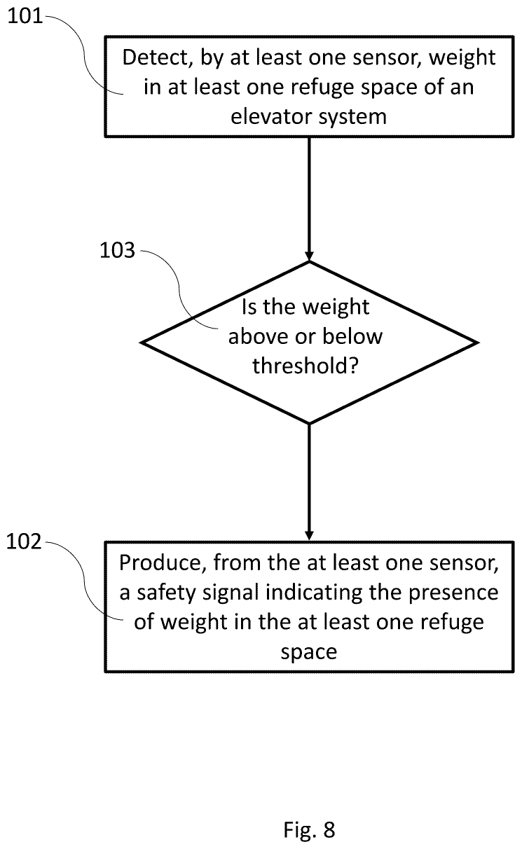

FIG. 8 shows an optional additional step to the method shown in FIG. 7. In these examples, the sensor 9 will only produce and send the safety signal if the weight is above and/or below a predetermined threshold. In some examples, the threshold is a minimum threshold. In these examples, the safety signal is not produced if the detected weight is below the minimum threshold. The purpose of this threshold is to not send safety signals for small or light objects that do not pose a risk (e.g. small pieces of debris).

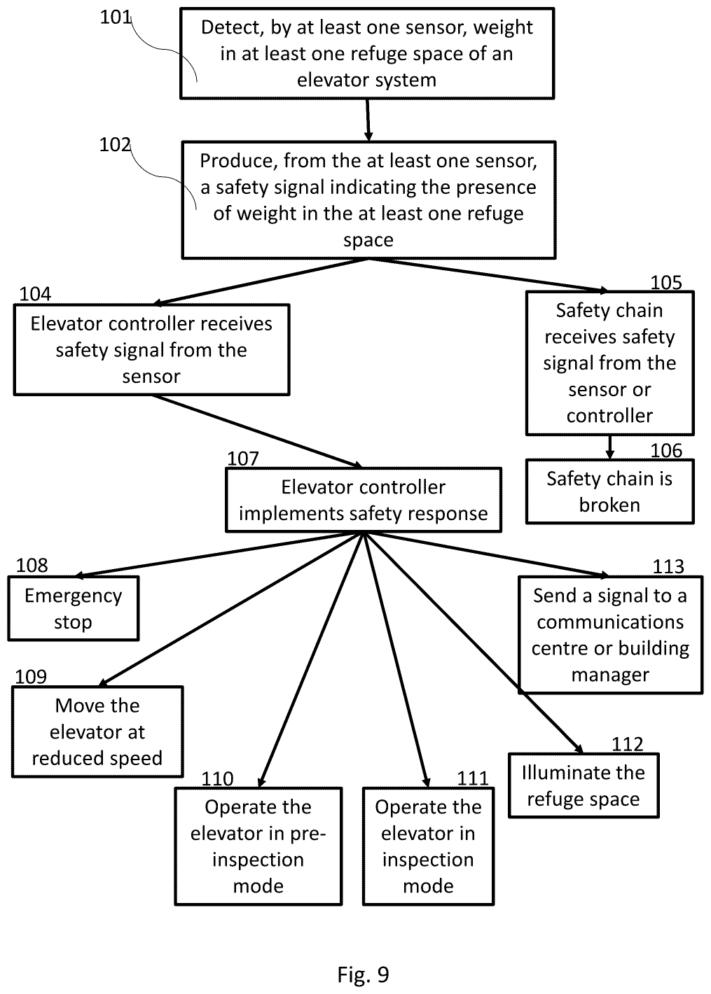

FIG. 9 shows further optional additional steps to the method shown in FIG. 7. In these examples, the safety signal is sent from the sensor(s) 9 to an elevator controller in step 104 and/or to the safety chain in step 105. If the safety signal is sent to the safety chain (step 105), the safety response is to break the safety chain 106. This can cause an emergency stop of the elevator car 2 by causing power to be cut to the elevator drive and the elevator brake (which causes the brake to drop).

If the safety signal is sent to the elevator controller in step 104, the elevator controller then implements a safety response in step 107. The safety response can include one or more of the following actions: an emergency stop in step 108, moving the elevator car at a reduced speed in step 109; operating the elevator system in a pre-inspection mode in step 110; operating the elevator system in an inspection mode in step 111; illuminating the refuge space (e.g. via light 13) in step 112; and/or sending a signal to a communications centre or building manager in step 113.

It will be appreciated that some examples may include the process from step 104 onwards and not the process from step 105 onwards. Other examples may include the process from step 105 onwards and not the process from step 104 onwards. Other examples may include both options of steps 104 and 105, which may be activated simultaneously or may be triggered by different scenarios, e.g. based on different weights or a combination of detected weight together with other situational data.

Although not shown in FIG. 9, it will be appreciated that the optional step 103 of FIG. 8 may also be included in the examples of FIG. 9, between steps 101 and 102.

What is claimed is:

1. An elevator system (1), comprising:
at least one refuge space (7, 8); and
at least one sensor (9);
wherein the at least one sensor (9) is configured to:
detect weight in the at least one refuge space (7, 8); and
produce at least one safety signal (21) indicating the presence of weight in the at least one refuge space (7, 8).

2. An elevator system (1) as claimed in claim 1, wherein the at least one refuge space (7) comprises a refuge space on the top of the elevator car (2); and/or
wherein the at least one refuge (8) space comprises a refuge space in the elevator pit.

3. An elevator system (1) as claimed in claim 1, wherein the at least one sensor (9) comprises sensitive flooring.

4. An elevator system (1) as claimed in claim 1, wherein the at least one sensor (9) comprises sensitive carpet.

5. An elevator system (1) as claimed in claim 1, wherein the at least one sensor (9) comprises a piezoelectric material.

6. An elevator system (1) as claimed in claim 1, wherein the at least one refuge space (7, 8) comprises one or more flat regions; and
wherein the at least one sensor (9) is positioned in at least one of the flat regions.

7. An elevator system (1) as claimed in claim 1, wherein the elevator system (1) comprises an elevator car (2) having a crosshead (11); and
wherein the at least one sensor (9) comprises a sensor (9) positioned on the crosshead (11).

8. An elevator system (1) as claimed in claim 1, wherein the at least one sensor (9) comprises at least one of a load sensor, a strain sensor, a stress sensor, and/or a pressure sensor.

9. An elevator system (1) as claimed in claim 1, wherein the at least one refuge space (7) comprises a refuge space on the top of the elevator car (2); and
wherein the at least one sensor (9) is embedded in or fixed to the underside of the roof (20) of the elevator car (2).

10. An elevator system (1) as claimed in claim 1, wherein the elevator system (1) further comprises an elevator controller (18), configured to receive the at least one safety signal (21) from the at least one sensor (9);
wherein, upon receiving the at least one safety signal (21) from the at least one sensor (9), the elevator controller (18) is configured to implement a safety response.

11. An elevator system (1) as claimed in claim 10, wherein the safety response comprises one or more of:
an emergency stop;
moving an elevator car (2) at a reduced speed;
operating the elevator system (1) in a pre-inspection operational mode;
operating the elevator system (1) in an inspection mode;
illuminating (13) the at least one refuge space (7, 8); and
sending a signal to a communications centre (22) or a building manager.

12. An elevator system (1) as claimed in claim 10, wherein the elevator controller (18) is configured to operate the elevator system (1) in a post-inspection mode when the at least one safety signal (21) is no longer received.

13. An elevator system (1) as claimed in claim 1, wherein the elevator system (1) further comprises a safety chain (19) configured to receive the at least one safety signal (21) from the at least one sensor (9);
wherein, upon receiving the at least one safety signal (21) from the at least one sensor (9), the safety chain (19) is broken.

14. An elevator system (1) as claimed in claim 1, wherein the at least one sensor (9) is arranged not to send the at least one safety signal (21) if the weight is below a minimum threshold;
optionally wherein the minimum threshold is no more than 50 kg, optionally no more than 30 kg, optionally no more than 20 kg, optionally no more than 10 kg, optionally no more than 5 kg.

15. A method of detecting objects in an elevator system (1) comprising:
detecting, by at least one sensor (9), weight in at least one refuge space (7, 8) of the elevator system (1);
producing, from the at least one sensor (9), at least one safety signal (21) indicating the presence of weight in the at least one refuge space (7, 8).
